(19) United States
(12) Patent Application Publication
(10) Pub. No.: US 2020/0192615 A1
(43) Pub. Date: Jun. 18, 2020

(54) PERFORMING ERROR RECOVERY FUNCTION

(71) Applicant: HEWLETT-PACKARD DEVELOPMENT COMPANY, L.P., Spring, TX (US)

(72) Inventor: Jung Woon JUNG, Pangyo (KR)

(73) Assignee: HEWLETT-PACKARD DEVELOPMENT COMPANY, L.P., Spring, TX (US)

(21) Appl. No.: 16/611,168

(22) PCT Filed: Jun. 20, 2018
(86) PCT No.: PCT/KR2018/006934

§ 371 Date: Nov. 5, 2019

(30) Foreign Application Priority Data
Sep. 29, 2017 (KR) 10-2017-0128306

(51) Int. Cl. G06F 3/12

(52) U.S. Cl. CPC G06F 3/1234; G06F 3/121; G06F 3/123; G06F 3/1238; G06F 3/1287

(57) ABSTRACT

An image forming apparatus having an error recovery function is provided. A communicator communicates with a cloud. A controller controls the image forming apparatus. The controller controls the image forming apparatus to detect an error occurring while a predetermined function is being executed, when the error is detected, access the cloud by using identification information of the image forming apparatus, transmit information about the error to the cloud, receive patch information for recovering from the error from the cloud, and recover from the detected error by using the patch information.

### BACKGROUND ART

An image forming apparatus refers to an office automation apparatus such as a printer, a copy machine, a scanner, or a facsimile machine for performing at least one function including printing, copying, scanning, and faxing. A multi-function peripheral (MFP) in which functions performed by multiple apparatuses such as a printer, a scanner, a copy machine, and a facsimile machine, are included in one apparatus has recently been widely distributed.

When a serious error occurs in an image forming apparatus, the image forming apparatus should rapidly address the error and be maintained in a normal state.

### BRIEF DESCRIPTION OF DRAWINGS

These and/or other aspects will become apparent and more readily appreciated from the following description of examples, taken in conjunction with the accompanying drawings in which:

FIG. 1 is a block diagram illustrating a configuration of an image forming apparatus according to an example;

FIG. 2 is a block diagram illustrating a system environment according to an example;

FIG. 3 is a diagram for explaining an operation by which an image forming apparatus recovers from an error according to an example:

FIG. 4 is a flowchart for explaining a method by which an image forming apparatus recovers from an error according to an example;

FIG. 5 is a diagram of a method by which an image forming apparatus recovers from an error in cooperation with a cloud according to an example;

FIGS. 6A through 6D are diagrams illustrating messages displayed on a user interface (UI) when an error occurs in an image forming apparatus according to an example;

FIG. 7 is a diagram illustrating a message displayed on a UI while a patch is executed in an image forming apparatus according to an example;

FIG. 8 is a diagram for explaining an operation by which error information is transmitted to an external network when a patch for an error does not exist in a cloud according to an example;

FIG. 9 is a flowchart for explaining an operation by which an image forming apparatus performs a monitoring mode when a patch for an error does not exist in a cloud according to an example;

FIGS. 10A through 10D are diagrams illustrating messages displayed on a UI of an image forming apparatus to request user identification (ID) information for executing a monitoring mode according to an example:

FIGS. 11A and 11B are diagrams illustrating messages for patch update monitoring and patch update notification in a monitoring mode according to an example;

FIG. 12 is a flowchart for explaining an operation according to a user input that selects a recovery mode or a normal mode when an error occurs in an image forming apparatus according to an example;

FIG. 13 is a diagram for explaining data communication between an image forming apparatus and a cloud according to an example;

FIGS. 14A through 14C are diagrams for explaining information transmitted/received between an image forming apparatus and a cloud according to an example;

FIG. 15 is a diagram illustrating a structure of error information transmitted by an image forming apparatus to a cloud according to an example;

FIG. 16 is a flowchart for explaining a process by which a cloud searches for patch information according to error information according to an example;

FIG. 17 is a diagram for explaining patch information stored in a cloud according to an example;

FIG. 18 is a diagram for explaining content of patch information transmitted by a cloud to an image forming apparatus according to an example;

FIG. 19 is a diagram for explaining content of a patch script executed by an image forming apparatus according to an example;

FIG. 20 is a diagram for explaining a structure of a log obtained after a patch stored in a cloud is executed according to an example;

FIG. 21 is a diagram for explaining error information transmitted to an external network when a patch for an error does not exist in a cloud according to an example; and

FIG. 22 is a diagram for explaining information of a message transmitted by an image forming apparatus to request a cloud for patch information according to an example.

### MODE FOR THE INVENTION

Hereinafter, examples will be described with reference to the accompanying drawings. The examples may, however, be embodied in many different forms and should not be construed as being limited to those in the following description. Rather, the following description and the attached drawings are provided for a better understanding of the present disclosure. Descriptions of techniques or structures related to the present disclosure which would be obvious to one of ordinary skill in the art will be omitted.

It will be understood that when an element is referred to as being “connected to” another element, it may be “directly connected to” the other element or “connected to the other element with intervening elements therebetween.” Also, it will be further understood that when a part “includes” or “comprises” an element, unless otherwise defined, the part may further include other elements, not excluding the other elements.

The term “image forming job” as used herein may refer to any one of various jobs (e.g., printing, copying, scanning, or faxing) related to an image, such as forming an image or generating/storing/transmitting an image file, and the term “job” may refer to not only an image forming job but may also refer to a series of processes required to perform the image forming job.

Also, the term “image forming apparatus” may refer to any apparatus capable of performing an image forming job, such as a printer, a scanner, a fax machine, a multifunction peripheral (MFP), or a display apparatus.

Also, the term “content” may refer to any type of data that is a target of an image forming job, such as a picture, an image, a document file, or the like.

Also, the term “print data” may refer to data having a format printable by a printer. In this case, “content” may include content having a format printable by a printer. For example, printing content may denote that content having a print data format is printed.

Also, the term “scan file” may refer to a file generated by scanning an image by using a scanner.

Also, the term “user” may refer to a person who performs an operation associated with an image forming job by using an image forming apparatus or a device connected by wire or wirelessly to the image forming apparatus.

Expressions such as “at least one of.” when preceding a list of elements, modify the entire list of elements and do not modify the individual elements of the list.

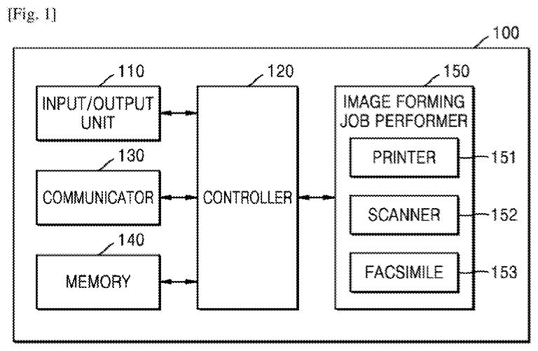

FIG. 1 is a block diagram illustrating a configuration of an image forming apparatus according to an example.

FIG. 2 is a block diagram illustrating a system environment according to an example.

Referring to FIG. 1, an image forming apparatus 100 may include an input/output unit 110, a controller 120, a communicator 130, a memory 140, and an image forming job performer 150. Also, although not shown in FIG. 1, the image forming apparatus 100 may further include a power supply unit for supplying power to each of the elements. Also, the image forming apparatus 100 may be an apparatus on which an extensible open architecture (XOA) is mounted.

The input/output unit 110 may include an input unit for receiving an input for performing an image forming job from a user, and an output unit for displaying information such as a result of the image forming job or a state of the image forming apparatus 100. For example, the input/output unit 110 may include an operation panel configured to receive a user input and a display panel configured to display a screen.

As an example, the input unit may include any of devices for receiving various types of user inputs, such as a keyboard, physical buttons, a touchscreen, a camera, and a microphone. Also, the output unit may include, for example, a display panel or a speaker. However, the present disclosure is not limited thereto, and the input/output unit 110 may include any of devices that support various inputs and outputs.

Also, the input/output unit 110 may include its own control system. That is, separately from the controller 120 of the image forming apparatus 100, the input/output unit 110 may include a control system (e.g., a controller and a memory) for controlling a user interface (UI) provided by the input/output unit 110. An operating system (OS) for providing the UI and programs such as applications for supporting various functions may be installed in the control system of the input/output unit 110.

The controller 120 may control an overall operation of the image forming apparatus 100, and may include a processor such as a central processing unit (CPU). The controller 120 may control other elements included in the image forming apparatus 100 to perform an operation corresponding to a user input received through the input/output unit 110.

For example, the controller 120 may execute a program stored in the memory 140, may read data or a file stored in the memory 140, or may store a new file in the memory 140.

Also, when job information and identification (ID) information related to printing of content are received from an external apparatus or a server connected to the external apparatus through the communicator 130, ID information may be received from the user through the input unit of the input/output unit 110. If the ID information received from the user and the ID information received from the external apparatus or the server correspond to each other, the controller 120 may control the communicator 130 to transmit accounting information based on the job information to a payment system. Also, when payment completion information according to payment by the user is received through the communicator 130, the controller 120 may print the content based on the job information.

In this case, when the ID information received from the user and the ID information received from the external apparatus or the server correspond to each other, it may mean that the ID information received from the user and the ID information received from the external apparatus or the server match each other.

Also, the controller 120 may control the communicator 130 to transmit content print completion information according to completion of the printing of the content to the payment system.

Also, when the ID information received from the user and the ID information received from the external apparatus or the server correspond to each other, the controller 120 may control the output unit of the input/output unit 110 to display a job information list including the job information. When the job information is selected from the job information list, the controller 120 may control the communicator 130 to transmit the accounting information to the payment system.

The communicator 130 may communicate with another device or a network by wire or wirelessly. To this end, the communicator 130 may include a communication module that supports at least one of various wired/wireless communication methods. For example, the communication module may be in the form of a chipset or a sticker/barcode (e.g., a sticker including a near-field communication (NFC) tag) including information needed for communication.

Wireless communication may include at least one of, for example, Wireless Fidelity (Wi-Fi), Wi-Fi Direct (WFD), Bluetooth, Ultra-wideband (UWB), and NFC. Wired communication may include at least one of, for example, a universal serial bus (USB) and a high-definition multimedia interface (HDMI).

The communicator 130 may be connected to an external apparatus 200 located outside the image forming apparatus 100 and may transmit/receive a signal or data to/from the external apparatus 200. FIG. 2 illustrates an image forming apparatus 100 according to an example, connected to a host device 200 or a server 300. As shown in FIG. 2, the image forming apparatus 100 may be connected to the external apparatus 200 through the communicator 130. The communicator 130 may transmit a signal or data received from the external apparatus 200 to the controller 120, or may transmit a signal or data generated by the controller 120 to the external apparatus 200. For example, when the communicator 130 receives a print command signal or print data from the external apparatus 200, the controller 120 may output the received print data through a printer 151.

Referring to FIG. 2, the external apparatus 200 may include an input/output unit 210, a controller 220, a communicator 230, and a memory 240. The controller 220 may control an image forming job by executing a program stored in the memory 240 and transmitting a signal or data generated as a result of the executed program to the image forming apparatus 100 through the communicator 230. Examples of the external apparatus 200 may include a smartphone, a tablet, a personal computer (PC), a home appliance, a medical device, a camera, and a wearable device.

The communicator 130 may be directly connected to the server 300 and may transmit/receive a signal or data to/from the server 300. Also, the communicator 130 may be connected to the external apparatus 200 through the server 300. That is, the communicator 130 of the image forming apparatus 100 may transmit/receive a signal or data to/from the communicator 230 of the external apparatus 200 through the server 300.

Referring back to FIG. 1, programs such as applications and various types of data such as files may be installed and stored in the memory 140. The controller 120 may access data stored in the memory 140 to use the data, or may store new data in the memory 140. Also, the controller 120 may execute a program installed in the memory 140 and may install an application received from an external source through the communicator 130 in the memory 140.

The image forming job performer 150 may perform an image forming job such as printing, copying, scanning, or faxing.

Although the image forming job performer 150 includes the printer 151, a scanner 152, and a facsimile 153 in FIG. 1, the image forming job performer 150 may include only some of the illustrated elements or may further include other elements for performing another type of image forming job, if necessary.

The printer 151 may form an image on a recording medium by using any of various printing methods such as an electrophotography method, an inkjet method, a thermal transfer method, and a direct thermal method.

The scanner 152 may emit light to a document, may receive reflected light, and may read an image recorded on the document. A charge-coupled device (CCD) or a contact-type image sensor (CIS) may be used as an image sensor for reading the image from the document. The scanner 152 may have a flatbed structure in which the document is located at a fixed position and the image sensor reads the image while moving, a document feed structure in which the image sensor is located at a fixed position and the document is fed, or a complex structure thereof.

The facsimile 153 may share a component for scanning an image with the scanner 152, may share a component for printing a received file with the printer 151, and may transmit a scan file to a destination or may receive a file from an external source.

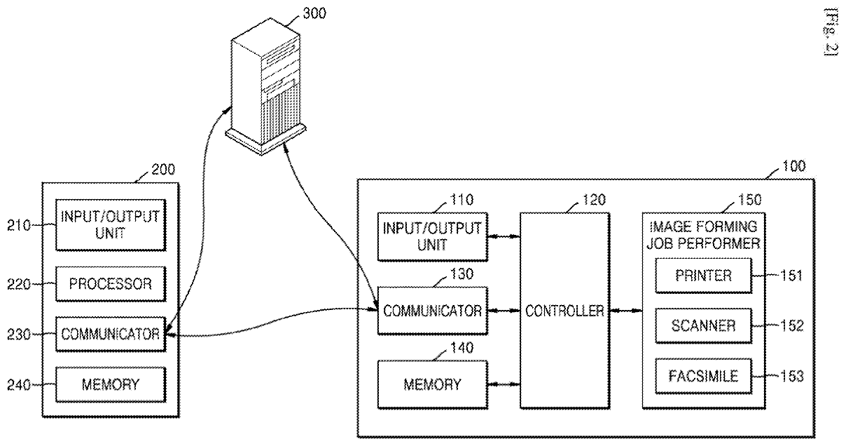

FIG. 3 is a diagram for explaining an operation by which an image forming apparatus recovers from an error according to an example.

Referring to FIG. 3, a user 1 may transmit a user input for executing a predetermined function to the image forming apparatus 100 in operation S301. For example, the user 1 may execute a function using any one or printing, faxing, copying, and scanning by using the image forming apparatus 100, may execute a function using a network by using the image forming apparatus 100, or may execute a function of user settings by using the image forming apparatus 100.

In an example, an error may occur when an application program related to a function of the image forming apparatus 100 is executed. Processes of the application programs related to the function of the image forming apparatus 100 and various application programs based on an open architecture are processed. For example, the image forming apparatus 100 performs various application programs such as an engine control application program, a UI control application program, a network interface application program, an image forming control application program, a scan data processing application program, an address book application program, a document box application program, and the like.

In operation S302, an error may occur in the image forming apparatus 100. As an example, the image forming apparatus 100 may detect the error when there is no response to a communication with an application program for executing the predetermined function by the user.

In operation S303, the image forming apparatus 100 may transmit error information to a cloud 400. The image forming apparatus 100 may operate in a recovery mode when the error is detected. The image forming apparatus 100 may access the cloud 400 by using ID information such as device information (e.g., a model identifier (ID) or a serial number of the image forming apparatus 100) and cloud account information (e.g., an ID or a password).

In operation S304, the cloud 400 may transmit information to address the error (e.g., patch information) to the image forming apparatus 100. The cloud 400 may search for a patch corresponding to the error information transmitted by the image forming apparatus 100. When the patch corresponding to the error exists, the cloud 400 may transmit the patch information for the error to the image forming apparatus 100.

In operation S305, the image forming apparatus 100 may recover from the error by using the patch information. The image forming apparatus 100 may access a web page for executing the patch by using a uniform resource locator (URL) included in the patch information. The image forming apparatus 100 may display the web page by using an output unit. The output unit may include a display.

In operation S306, the image forming apparatus 100 may transmit a recovery result of the detected error to the cloud 400. The image forming apparatus 100 may transmit, to the cloud 400, log information including information about whether the application of the patch succeeds, an application time, a patch ID, the model ID and/or the serial number of the image forming apparatus 100, and the like.

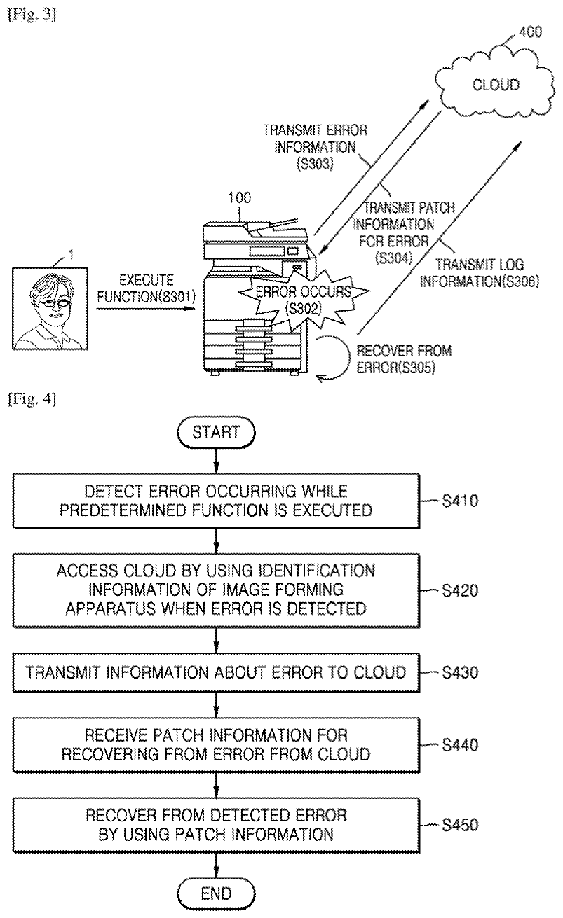

FIG. 4 is a flowchart for explaining a method by which an image forming apparatus recovers from an error according to an example.

Referring to FIG. 4, the image forming apparatus 100 may detect an error occurring while a predetermined function is executed in operation 8410.

In operation S420, when the error is detected, the image forming apparatus 100 may access a cloud by using ID information of the image forming apparatus 100. The ID information of the image forming apparatus 100 may include a model ID and a serial number of the image forming apparatus 100, and cloud account information.

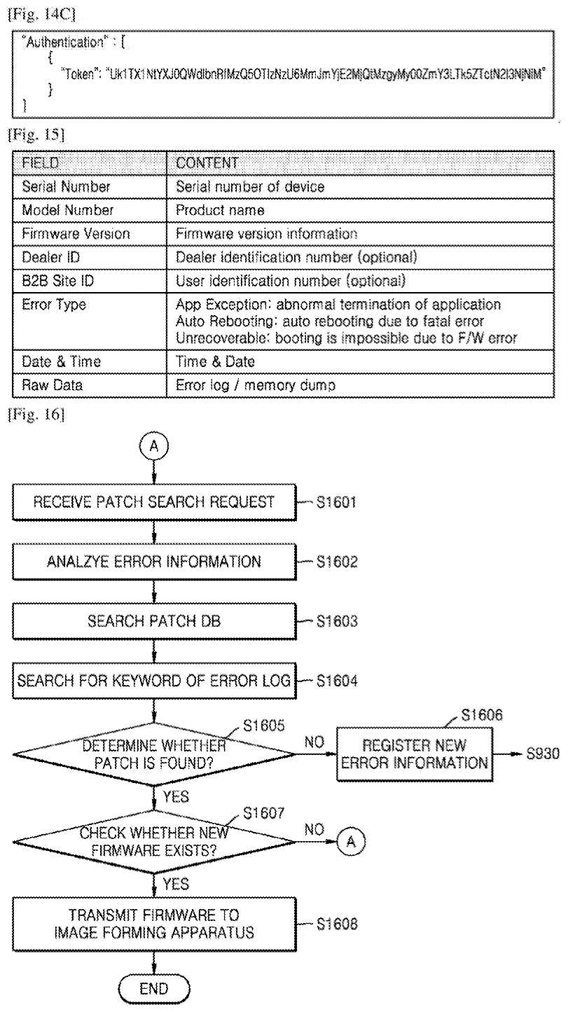

In operation S430, the image forming apparatus 100 may transmit information about the error to the cloud. The information about the error will be explained below with reference to FIG. 15.

In operation S440, the image forming apparatus 100 may receive patch information for recovering from the error from the cloud. In operation S450, the image forming apparatus 100 may recover from the error by installing a patch included in the patch information, which will be explained below in more detail.

FIG. 5 is a diagram of a method by which an image forming apparatus recovers from an error in cooperation with a cloud according to an example.

Referring to FIG. 5, the user 1 may execute a predetermined function of the image forming apparatus 100 in operation S501.

In operation S502, the image forming apparatus 100 may detect an error occurring when the predetermined function is executed. The image forming apparatus 100 may determine that the error occurs when the predetermined function is not executed even though the predetermined function is instructed to be executed.

In operation S503, the image forming apparatus 100 may execute a recovery mode. The image forming apparatus 100 may store a log about the error in a flash memory, may set a recovery flag, and may execute the recovery mode. When the recovery mode is executed in the image forming apparatus 100, the image forming apparatus 100 may try to access the cloud 400. The image forming apparatus 100 may access the cloud 400 by using ID information such as an ID and a password for accessing the cloud 400.

In operation S504, the image forming apparatus 100 may transmit ID information of the image forming apparatus 100 and error information to the cloud 400.

In operation S505, the cloud 400 may determine patch information for recovering from the error. The cloud 400 may compare the error information received from the image forming apparatus 100 with a plurality of pieces of error information that are previously stored. The plurality of pieces of error information stored in the cloud 400 correspond to errors having already occurred in the image forming apparatus 100 or a similar image forming apparatus, and patches for recovering from the errors exist. The plurality of pieces of error information respectively include the patches for recovering from the errors. When the error is the same as any one of a plurality of errors stored in the cloud 400, the cloud 400 may determine a patch corresponding to the error. The cloud 400 may generate patch information to be transmitted to the image forming apparatus 100.

In operation S506, the cloud 400 may transmit the patch information to the image forming apparatus 100.

In operation S507, the image forming apparatus 100 may notify error recovery and patch execution by using the patch information. The image forming apparatus 100 may access a web page by using a URL included in the patch information and may display a guide provided by the web page on a display.

In operation S508, the image forming apparatus 100 may receive an input that selects the patch execution from the user 1. The image forming apparatus 100 may execute the patch according to the user's intention by notifying the patch execution to the user 1. Since the image forming apparatus 100 requests the user to select whether to execute the patch, data stored in the image forming apparatus 100 may be prevented from being lost.

In operation S509, the image forming apparatus 100 may execute the patch according to the user's input that selects the patch execution. When the patch is executed, the image forming apparatus 100 may automatically execute a patch script included in the patch information, and may display the progress of the patch on the display or a UI.

In operation S510, the image forming apparatus 100 is rebooted or an image forming job is otherwise resumed when the patch execution is completed.

In operation S511, the image forming apparatus 100 may transmit, to the cloud 400, log information including information about whether the application of the patch succeeds, an application time, a patch ID, a model ID and/or a serial number of the image forming apparatus 100, and the like.

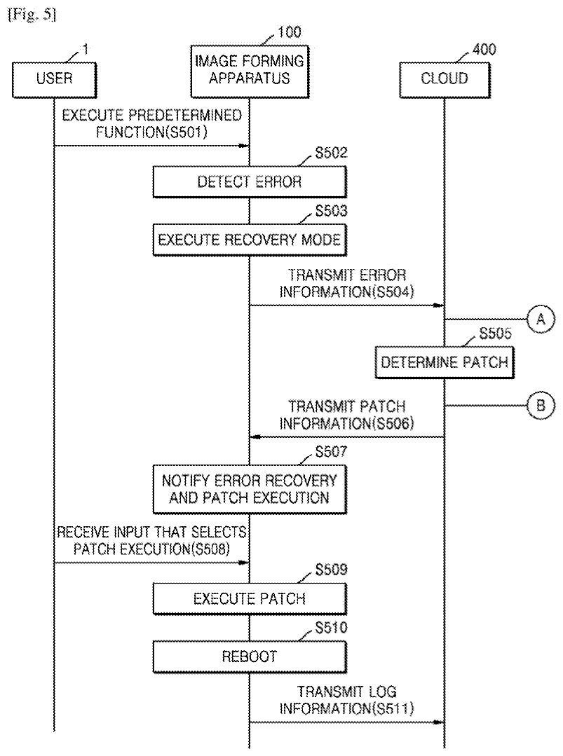

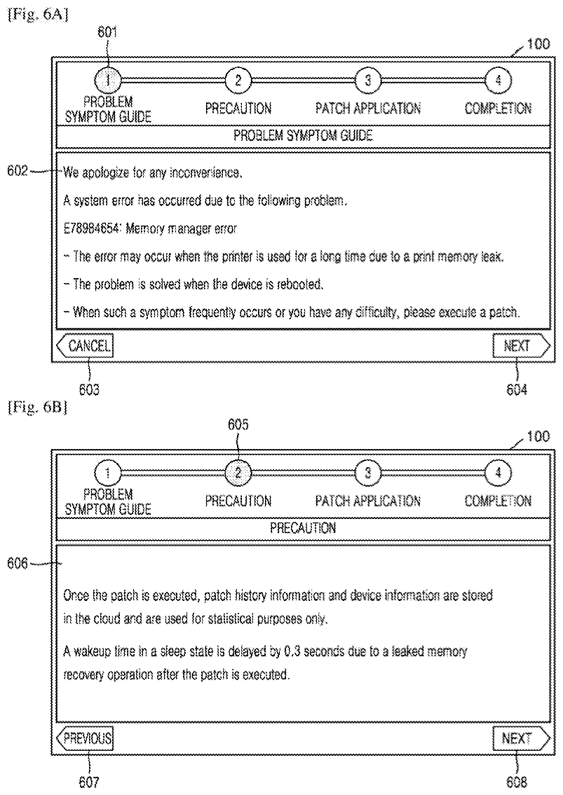

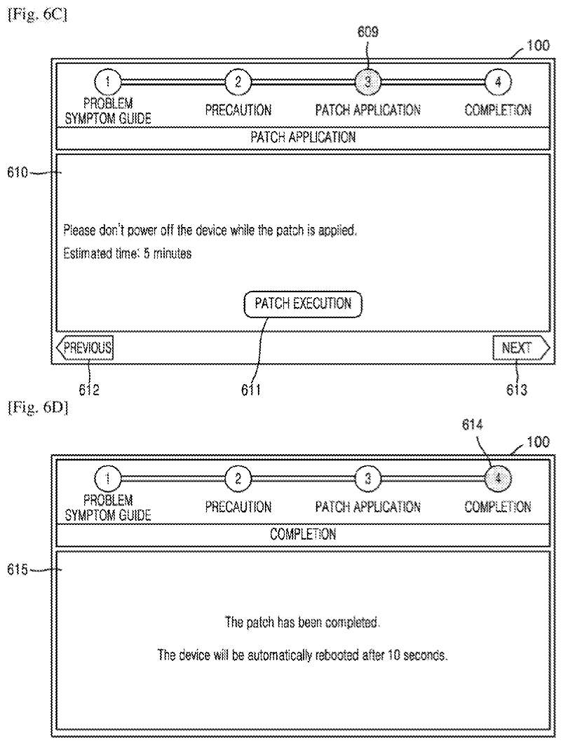

FIGS. 6A through 6D are diagrams illustrating messages displayed on a UI when an error occurs in an image forming apparatus according to an example.

According to an example, the image forming apparatus 100 may display a process in which a patch is executed on the UI.

Referring to FIGS. 6A through 6D, upon examining the UI, a problem symptom guide page 601, a precaution page 605, a patch application page 609, and a completion page 614 may be provided.

Information 602 about content of an error may be displayed on the problem symptom guide page 601 of FIG. 6A. For example, a cause of the error, a type of a function in which the error occurs, a method to address the error, and a patch installation guide may be displayed. When a user selects a “cancel” button 603, a patch is not executed and is canceled. When the patch is canceled, the image forming apparatus 100 may terminate a recovery mode and may perform a normal mode. In the normal mode, the function in which the error occurs may be deactivated.

When the user presses a “next” button 604, the problem symptom guide page 601 may be turned to the precaution page 605 for executing the patch.

Content 606 about precautions when the patch is executed may be displayed on the precaution page 605 of FIG. 6B. For example, content indicating that information of the image forming apparatus 100, information of the error, content of the patch, and whether to apply the patch when the patch is executed may be transmitted to and stored in the cloud 400 may be displayed. Also, a notice about an operation of the image forming apparatus 100 after the patch is executed may be displayed.

When the user presses a “previous” button 607, the precaution page 605 may return to the problem symptom guide page 601, and when the user presses a “next” button 608, the precaution page 605 may be turned to the patch application page 609 for executing the patch.

A “patch execution” button 611 and a notice 610 for patch application may be displayed on the patch application page 609 of FIG. 6C. The notice 610 for the patch execution may include ID information of the patch, a time taken to execute the patch, precautions while the patch is executed, and the like.

When the “patch execution” button 611 is pressed, the patch is executed, which will be explained with reference to FIG. 7.

When the user presses a “previous” button 612, the patch application page 609 returns to the precaution page 605. When the patch execution is completed and a “next” button 613 is pressed, the patch application page 609 may be turned to the completion page 614.

A message 615 about the completion of the patch may be displayed on the completion page 614 of FIG. 6D, and it may be notified that the image forming apparatus 100 is automatically rebooted due to the completion of the patch.

FIG. 7 is a diagram illustrating a message displayed on a UI while a patch is executed in an image forming apparatus according to an example.

Referring to FIG. 7, when the “patch execution” button 611 is selected in FIG. 6C, a color of a “patch execution” button 703 may be changed on a patch application page 701 and information indicating that the patch is being executed may be displayed. Also, a precaution message 702 may be displayed while the patch is executed and a progress 704 of the patch may be displayed in real time to a user.

FIG. 8 is a diagram for explaining an operation by which error information is transmitted to an external network when a patch for an error does not exist in a cloud according to an example.

Operations S801 through S803 of FIG. 8 are substantially the same as operations S301 through S303 of FIG. 3, and thus a detailed explanation thereof will not be given.

Referring to FIG. 8, when error information matching error information received from the image forming apparatus 100 does not exist, the cloud 400 may determine that a patch for recovering from the error information does not exist in operation S804. The cloud 400 may transmit the error information to an external network through a network interface unit. In particular, the cloud 400 may transmit the error information to a developer 500 that is pre-designated.

In operation S805, when it is determined that the patch corresponding to the error information does not exist, the developer 500 may send a service request to a service center 600. The service center 600 may dispatch a service staff member for fixing an error to a user.

In operation S806, the cloud 400 may notify the image forming apparatus 100 that the patch corresponding to the error does not exist.

FIG. 9 is a flowchart for explaining an operation by which an image forming apparatus performs a monitoring mode when a patch for an error does not exist in a cloud according to an example.

Referring to FIG. 9, a flowchart illustrating a process after the image forming apparatus 100 transmits error information to the cloud 400 is provided.

In operation S910, the cloud 400 may compare an error detected by the image forming apparatus 100 with a plurality of errors that are previously stored. A type of the error, a cause of the error, etc. included in error information may be compared with a plurality of pieces of error information that are stored.

In operation S920, the cloud 400 may determine whether the error detected by the image forming apparatus 100 exists among the errors that are stored.

When the same error as the error in the error information detected by the image forming apparatus 100 exists, the operation of FIG. 9 proceeds to operation S505.

In operation S930, the cloud 400 may transmit information about the detected error to an external network through a network interface unit.

The external network may include a network connected to at least one of a terminal device used by a user, a terminal device used by a manager of the image forming apparatus 100, a remote management server for remote management of the image forming apparatus 100, and the like.

In operation S940, the image forming apparatus 100 may execute a monitoring mode by receiving user ID information.

The image forming apparatus 100 may request the user to check whether to update, in the cloud 400, the user ID information along with log information that records information about the error, according to a response of the cloud 400 indicating that a patch does not exist.

When the user permits to update the user ID information and the log information in the cloud 400, the image forming apparatus 100 may transmit the user ID information and the log information to the cloud 400. In this case, since the log information is already transmitted when the error information is transmitted, the image forming apparatus 100 may transmit only the user ID information.

When the user permits to update the user ID information and the log information, the image forming apparatus 100 may execute the monitoring mode.

In operation S950, in the monitoring mode, the image forming apparatus 100 may check whether the patch is updated by periodically monitoring the cloud 400. The image forming apparatus 100 may check whether the patch is updated in the cloud 400 in a predetermined cycle. The image forming apparatus 100 may check whether the patch is updated in the cloud 400 by using a monitoring application.

In operation S960, the image forming apparatus 100 may receive the updated patch from the cloud 400. When the cloud 400 receives a patch confirmation request, the cloud 400 may check whether an issue ID, a model name, a serial number, a firmware version, etc. included in the patch confirmation request are the same as information registered on the cloud 400. The cloud 400 may transmit a firmware URL or a URL of the updated patch for the error to the image forming apparatus 100.

Also, the cloud 400 may transmit a notification that the patch is updated to the user with contact information of the user.

In operation S970, the image forming apparatus 100 may recover from the error by executing the patch.

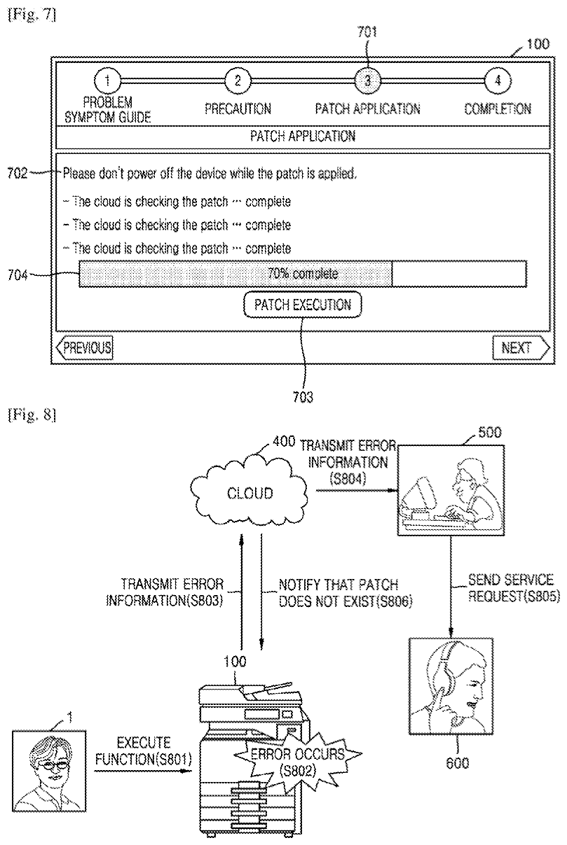

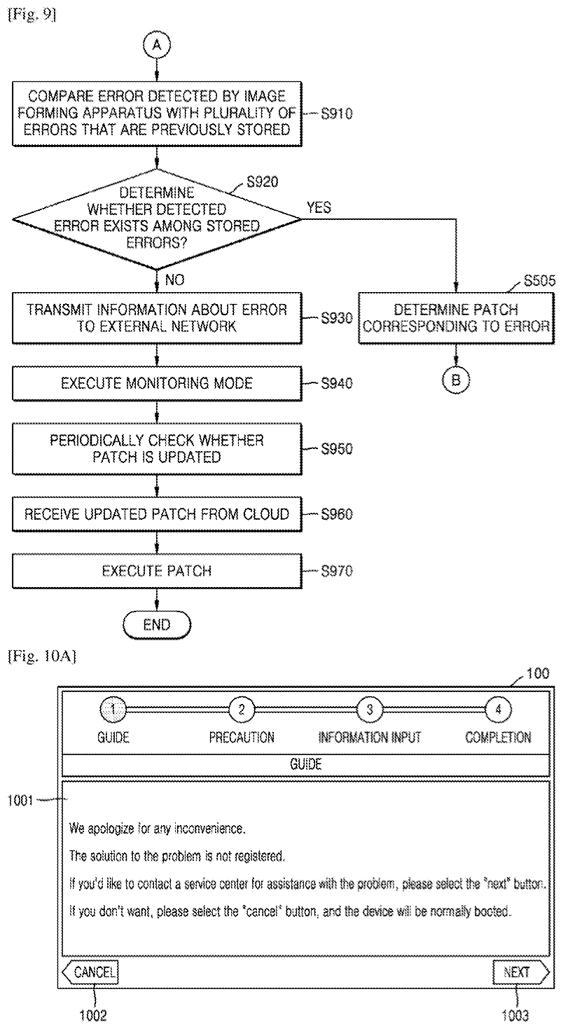

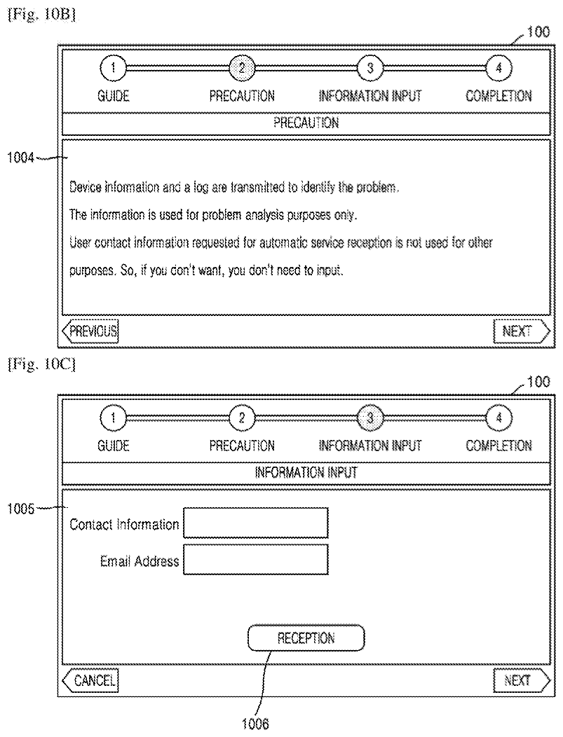

FIGS. 10A through 10D are diagrams illustrating messages displayed on a UI of an image forming apparatus to request user ID information for executing a monitoring mode according to an example.

According to an example, FIGS. 10A through 10D illustrate a screen displayed on the UI of the image forming apparatus 100 when a notification that a patch corresponding to an error does not exist in a cloud is received.

Referring to FIG. 10A, a message 1001 indicating that a patch for an error does not exist and thus a problem may not be immediately addressed may be displayed in a guide step.

The message 1001 may include content indicating that when a “next” button 1003 is selected to address the error, a monitoring mode starts and when the monitoring mode is not wanted and a “cancel” button 1002 is selected, a normal mode starts.

Referring to FIG. 10B, a message 1004 about precautions may be displayed. The message 1004 about the precautions may include content indicating that device information and log information are transmitted to a cloud to address the error. The device information refers to information of the image forming apparatus 100.

In FIG. 10C, the image forming apparatus 100 may display a screen 1005 to receive contact information such as an email address, a social network service (SNS) address, a telephone number, etc. from a user who agrees to use personal information through the UI. When the user inputs the contact information and presses a “reception” button 1006, a screen may be changed to a completion screen of FIG. 10D.

In FIG. 10D, the image forming apparatus 100 may display a message 1007 for error recovery. The message 1007 may include content about automatic rebooting. The image forming apparatus 100 may be automatically rebooted and may operate in the monitoring mode.

FIGS. 11A and 11B are diagrams illustrating messages for patch update monitoring and patch update notification in a monitoring mode according to an example.

Referring to FIG. 11A, the image forming apparatus 100 may display a screen 1101 for setting a cycle in which patch update of the cloud 400 is checked in a monitoring mode. A user may set a cycle in which patch update is checked. As an example, the cycle may be set, but is not limited to, once per day, once per booting, or once per hour.

An operation of monitoring the patch update may be performed by a controller or a patch monitoring application of the image forming apparatus 100.

The image forming apparatus 100 may access the cloud 400 in the set cycle. The image forming apparatus 100 may check the patch update of the cloud 400 by using an issue ID of an error included in error information.

Referring to FIG. 11B, a notification message 1102 may be displayed by the image forming apparatus 100 when a patch is updated in the cloud 400.

The notification message 1102 when the patch is updated may include information about the patch update and the error information. When the user presses a “patch execution” button 1103, the patch is executed, and when a “notification cancel” button 1104 is pressed, a notification is not transmitted to the image forming apparatus 100 even though the patch is updated.

FIG. 12 is a flowchart for explaining an operation according to a user input that selects a recovery mode or a normal mode when an error occurs in an image forming apparatus according to an example.

Referring to FIG. 12, the image forming apparatus 100 may receive a user input that selects a recovery mode or a normal mode in operation S1201. When an error is detected, the image forming apparatus 100 may request a user to select a mode from among a recovery mode in which the error is to be immediately recovered and a normal mode in which the error is to be recovered later.

When the user selects the recovery mode, operation 503 of FIG. 5 is executed.

When the user selects the normal mode, the operation of FIG. 12 proceeds to operation S1202. The image forming apparatus 100 may deactivate a predetermined function. The image forming apparatus 100 may provide another function by deactivating the predetermined function. Since the error is detected when the predetermined function is executed, the error is not detected when a function other than the predetermined function is executed.

In operation S1203, the image forming apparatus 100 may receive a user input that executes the predetermined function once again. The image forming apparatus 100 may re-detect the error as the predetermined function is executed. In this case, the image forming apparatus 100 that re-detects the error may request the user to select a mode from among the recovery mode and the normal mode once again.

Accordingly, even when the user may not use a specific function of the image forming apparatus 100 due to an error, another function may be used.

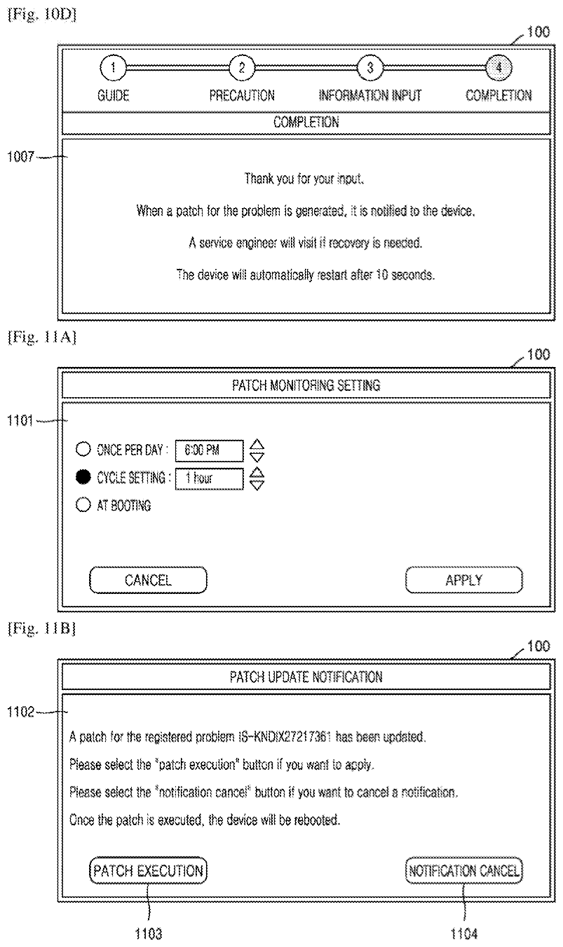

FIG. 13 is a diagram for explaining data communication between an image forming apparatus and a cloud according to an example.

Referring to FIG. 13, the image forming apparatus 100 may transmit information including URL information to the cloud 400. The cloud 400 may perform an authentication process based on error information and ID information of the image forming apparatus 100 provided by the image forming apparatus 100. When the authentication process is completed, the cloud 400 may provide information to the image forming apparatus 100 by using a token.

The image forming apparatus 100 may store the token, and may use the token as authentication information when communicating with the cloud 400 in the future.

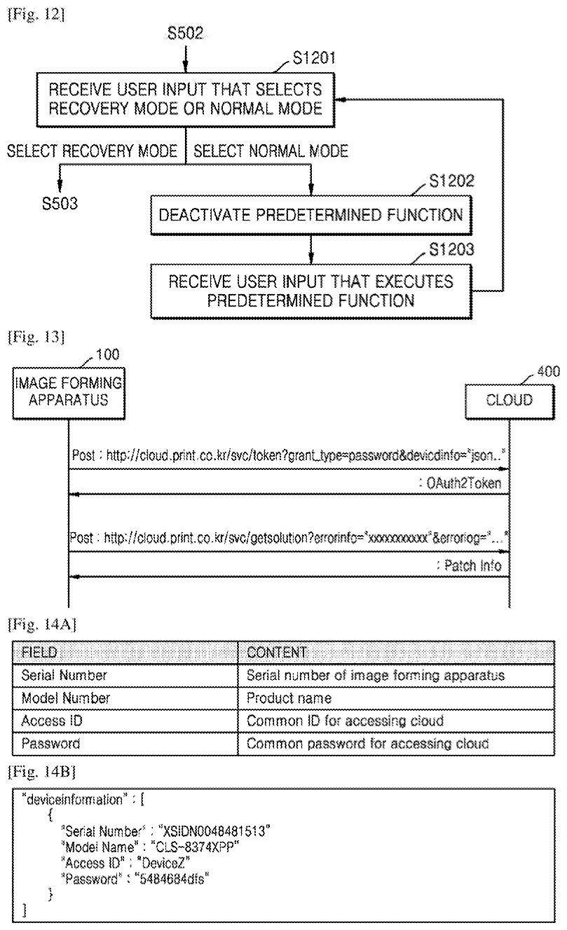

FIGS. 14A through 14C are diagrams for explaining information transmitted/received between an image forming apparatus and a cloud according to an example.

FIG. 14A illustrates content about information provided by the image forming apparatus 100 to the cloud 400. The image forming apparatus 100 may provide information including a serial number, a model number, an access ID, and a password to the cloud 400. The serial number is a serial number of the image forming apparatus 100, the model number is a product name, the access ID is a common ID for accessing the cloud 400, and the password is a common password for accessing the cloud 400.

FIG. 14B illustrates a structure of data that may be transmitted by the image forming apparatus 100 to the cloud 400 according to an example. The data structure may include a serial number, a model number, an access ID, and a password of the image forming apparatus 100. FIG. 14C illustrates a structure of data that may be transmitted by the cloud 400 to the image forming apparatus 100 according to an example. In the illustrated example, the cloud 400 may provide information to the image forming apparatus 100 by using a token.

FIG. 15 is a diagram illustrating a structure of error information transmitted by an image forming apparatus to a cloud according to an example.

Referring to FIG. 15, error information may include at least one of information from among a serial number, a model number, a firmware version, a dealer ID, a B2B site ID, an error type, a date, a time, raw data, and the like.

The serial number is a serial number of a device, that is, ID information of the image forming apparatus 100.

The error type corresponds to error information according to a type of an error. A patch corresponding to each error type may be needed to recover from the error.

The dealer ID is needed to address a problem occurring in a specific patch and specific firmware applied when the image forming apparatus 100 is used in an office. The specific patch and the specific firmware installed in the image forming apparatus 100 may be checked by using the dealer ID assigned to the image forming apparatus 100.

FIG. 16 is a flowchart for explaining a process by which a cloud searches for patch information according to error information according to an example.

Referring to FIG. 16, the cloud 400 may receive a patch search request from the image forming apparatus 100 in operation S1601. The patch search request may be included in error information received from the image forming apparatus 100.

In operation S1602, the cloud 400 may analyze the error information. In more detail, as shown in FIG. 15, ID information of an error may be checked by analyzing an error type.

In operation S1603, the cloud 400 may search a patch database (DB). The patch DB may include information about errors having occurred in the image forming apparatus 100 or similar image forming apparatuses and information about patches for recovering from the errors.

In operation S1604, the cloud 400 may search for a keyword of an error log. An example of a data structure of the error log is as follows.

No carrier sense—Check network cable.

ASSERT(0):

Location: /data/bas/input/54405/build/GV3_System/GV3_Source/Platform/Drv/NANDDrv/NAN DDrv_FileSystem.c, 1559

[DoAssert] ulFaxAssertJobID (0)

[DoAssert]Non Fax Job Case

Since the error log is usually generated in a simple and identical pattern, a patch may be easily found by using the error log.

The cloud 400 may search for the patch by comparing the keyword of the error log included in the error information received from the image forming apparatus 100 with a patch list of a cloud DB.

When it is determined in operation S1605 that the cloud 400 fails to find the patch, the process of FIG. 16 proceeds to operation S1606. In operation S1606, new error information may be registered. In this case, when the patch does not exist, operation S930 of FIG. 9 may be executed.

In operation S1607, the cloud 400 may check whether new firmware exists by checking a firmware version. The patch may be determined based on the firmware version, and when the firmware version is higher, firmware is installed prior to the patch. Accordingly, when it is determined in operation S1607 that the new firmware exists, the process of FIG. 16 proceeds to operation S1608. In operation S1608, even though the patch exists, the new firmware is transmitted to the image forming apparatus 100.

FIG. 17 is a diagram for explaining patch information stored in a cloud according to an example.

Referring to FIG. 17, patch information may be previously stored in the cloud 400. The patch information may include a patch ID, a model name, a firmware version, developer information, an error type, a log keyword, a dealer ID, a B21B site ID, patch URL information, firmware URL information, and the like.

As described above, the cloud 400 may determine a patch for recovering from an error by checking whether pieces of information included in error information match pieces of information included in the patch information.

The cloud 400 may search for the patch by using any one of the log keyword, the dealer ID, the B2B site ID, the patch URL information, the firmware URL information, and the like or a combination thereof along with the error type.

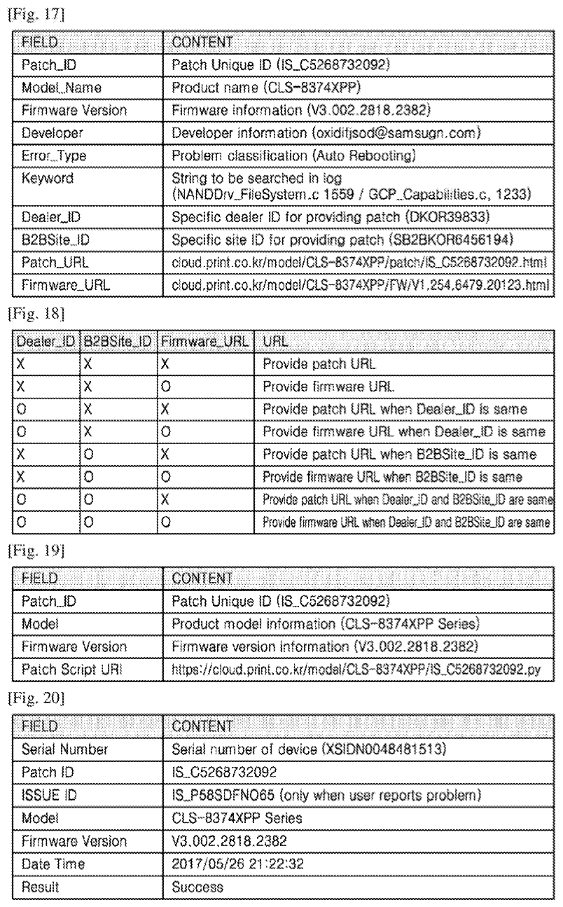

FIG. 18 is a diagram for explaining content of patch information transmitted by a cloud to an image forming apparatus according to an example.

Referring to FIG. 18, a table in which a patch or firmware is provided by combining a dealer ID, a B2B site ID, and a firmware URL is illustrated. The cloud 400 may determine a method of recovering from an error by combining error information and patch information.

For example, the cloud 400 may determine the patch information including a patch URL when the error information and the patch information are the same in the dealer ID and the B2B site ID and are different in the firmware URL. Alternatively, the cloud 400 may select a method of providing a firmware URL as a method of recovering from an error when the error information and the patch information are the same in the dealer ID, the B2B site ID, and the firmware URL.

FIG. 19 is a diagram for explaining content of a patch script executed by an image forming apparatus according to an example.

Referring to FIG. 19, when a user inputs a button that executes a patch in the image forming apparatus 100, the cloud 400 may transmit a patch script to the image forming apparatus 100. The image forming apparatus 100 may remove a recovery mode and a monitoring mode by using the patch script, may recover from an error, and may be rebooted or resume an image forming job.

The patch script may include a patch ID, product model information, a firmware version, a patch script URL, and the like.

The patch script may be written in extensible Python and may be modified into various extension scenarios. For example, in a case 1, new firmware may be downloaded from the cloud 400 and may be updated. In a case 2, an important file of the image forming apparatus 100 may be transmitted to the cloud 400, and a part of a file system may be formatted and partial update may be performed in the cloud 400. In a case 3, a file of the image forming apparatus 100 may be opened and data may be changed or stored. In a case 4, only some applications of firmware may be partially patched.

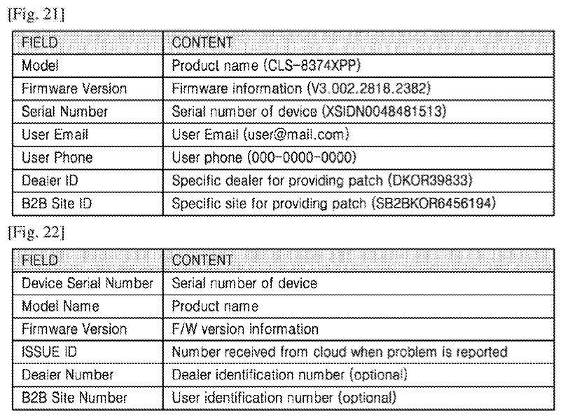

FIG. 20 is a diagram for explaining a structure of a log obtained after a patch stored in a cloud is executed according to an example.

Referring to FIG. 20, a resultant value obtained after a patch is executed by using a patch script may be as shown. A log value that is a result of the patch of FIG. 20 may be stored in the cloud 400 and the image forming apparatus 100.

FIG. 21 is a diagram for explaining error information transmitted to an external network when a patch for an error does not exist in the cloud 400 according to an example.

When a patch for an error does not exist in the cloud 400, a new patch needs to be developed. Accordingly, the cloud 400 may generate error information as shown in FIG. 21 and may transmit the error information to an external network. In this case, the error information includes a user email and contact information. When the new patch is updated, the cloud 400 may notify a user by using at least one of the user email and the contact information.

FIG. 22 is a diagram for explaining information of a message transmitted by an image forming apparatus to request a cloud for patch information according to an example.

Referring to FIG. 22, the illustrated table includes information transmitted by the image forming apparatus 100 to request the cloud 400 to periodically check for a patch update in a monitoring mode.

An issue ID is an identification number assigned by the cloud 400 when an error is detected, a patch does not exist, and the monitoring mode is selected. When the cloud 400 receives a request to check for a patch update, it is checked whether an issue ID, a model name, a serial number, and a firmware version included in the request are the same as information registered on the cloud 400. When the same information exists, the cloud 400 may transmit a patch URL or a firmware URL to the image forming apparatus 100 like in a patch application step.

The afore-described examples may be implemented as an executable program, and may be executed by a general-purpose digital computer that runs the program by using a computer-readable recording medium. Also, a structure of data used in the examples may be recorded by using various units on a non-transitory computer-readable storage medium. Examples of the computer-readable storage medium include storage media such as magnetic storage media (e.g., read-only memories (ROMs), floppy discs, or hard discs) and optically readable media (e.g., compact disk read-only memories (CD-ROMs), or digital versatile disks (DVDs)).

While one or more examples have been described with reference to the figures, it will be understood by one of ordinary skill in the art that various changes in form and details may be made therein without departing from the spirit and scope of the disclosure as defined by the following claims.

1. A method of performing an error recovery function, the method comprising:
detecting an error occurring while a first function is being executed;
when the error is detected, accessing a cloud by using identification information of an image forming apparatus;
transmitting information about the error to the cloud;
receiving, from the cloud, patch information for recovering from the error; and
recovering from the error by using the patch information,
wherein the detecting, the accessing, the transmitting, the receiving, and the recovering are performed by the image forming apparatus.

2. The method of claim 1, further comprising:
comparing the error detected by the image forming apparatus with a plurality of errors that are previously stored; and
when the error is the same as any one of the plurality of errors that are previously stored, transmitting the patch information corresponding to the error to the image forming apparatus,
wherein the comparing and the transmitting are performed by the cloud.

3. The method of claim 2, further comprising, when the patch information corresponding to the error does not exist, transmitting the information about the error to an external network through a network interface unit, wherein the transmitting is performed by the cloud,
wherein the external network is connected to at least one of a terminal device used by a user, a terminal device used by a manager of the image forming apparatus, or a remote management server for remote management of the image forming apparatus.

4. The method of claim 2, further comprising, when the patch information corresponding to the error does not exist in the cloud:
requesting a user for user identification information;
transmitting the user identification information received from the user to the cloud; and
executing a monitoring mode of the error.

5. The method of claim 2, further comprising, when the patch information corresponding to the error does not exist in the cloud, requesting the patch information corresponding to the error from a terminal device used by a manager of the image forming apparatus or a remote management server for remote management of the image forming apparatus.

6. The method of claim 4, wherein the executing of the monitoring mode comprises requesting the cloud to determine whether the patch information corresponding to the error is updated in a predetermined cycle.

7. The method of claim 4, wherein the executing of the monitoring mode comprises:
when the patch information corresponding to the error is updated in the cloud, receiving a notification about the updated patch information;
when the user executes the first function, displaying the notification about the updated patch information; and
when an input that executes the updated patch information is received from the user, recovering from the error by using the updated patch information.

8. The method of claim 7, further comprising, when the patch information corresponding to the error is updated in the cloud, transmitting a notification that the patch information is updated to the user with contact information of the user included in the user identification information, wherein the contact information of the user comprises at least one of an email address, a social network service (SNS) address, or a telephone number.

9. The method of claim 1, wherein the recovering from the error comprises:
accessing a web page by using a uniform resource locator (URL) included in the patch information;
requesting a user to determine whether to perform an error recovery process of the web page; and
executing a patch for error recovery when the user determines that the error recovery process is to be performed.

10. The method of claim 1, further comprising, when the error is detected while the first function is being executed, receiving an input that selects whether to execute a recovery mode or a normal mode from a user, wherein, when the recovery mode is selected, the cloud is accessed by using the identification information of the image forming apparatus, and when the normal mode is selected, the first function is deactivated.

11. The method of claim 10, further comprising, when a user input that executes the first function in the normal mode is received, requesting to select whether to execute the recovery mode or the normal mode.

12. The method of claim 1, wherein the error occurs while the first function is being executed, and is not detected when a function other than the first function is being executed.

13. The method of claim 1, wherein the recovering from the error comprises terminating a process in which the error has occurred and reexecuting the process by executing a patch.

14. The method of claim 1, further comprising, when the error is not recovered from after attempting to recover from the error, transmitting a log indicating the information about the error to the cloud.

15. An image forming apparatus having an error recovery function, the image forming apparatus comprising:
a communicator to communicate with a cloud; and
a controller to control the image forming apparatus,
wherein the controller controls the image forming apparatus to:
detect an error occurring while a function is being executed, when the error is detected, access the cloud by using identification information of the image forming apparatus,
transmit information about the error to the cloud,
receive, from the cloud, patch information for recovering from the error, and
recover from the error by using the patch information.
